(19) United States
(12) Patent Application Publication
(10) Pub. No.: US 2015/0092311 A1
(43) Pub. Date: Apr. 2, 2015

(54) METHODS, SYSTEMS, AND COMPUTER READABLE MEDIA FOR PROTECTION OF DIRECT CURRENT BUILDING ELECTRICAL SYSTEMS

(71) Applicant: ABB Technology AG

(72) Inventors: Zhenyuan Wang, Morrisville (US); Joseph A. Carr, Raleigh (US); Jing Xu, Cary (US); Juhua Liu, Cary (US)

(21) Appl. No.: 14/042,594

(22) Filed: Sep. 30, 2013

(51) Int. Cl. H02H 1/04; H02H 3/247; H02H 3/24; H02H 3/08

(52) U.S. Cl. CPC H02H 1/043; H02H 3/08; H02H 3/247; H02H 3/24
USPC 361/86; 361/93.1

(57) ABSTRACT

Methods, systems, and computer readable media for providing protection of DC building electrical systems are disclosed. According to one aspect, a system for over-current protection of direct current (DC) building electrical systems includes a DC bus for providing DC power to a building and multiple DC feeder conductors for providing DC power to multiple locations within the building. Each DC feeder conductor is connected to the DC bus via a DC protection module having a fuse, a normally closed switch connected in parallel with the fuse, and a circuit breaker connected in series with the fuse and switch, where the switch is controllable to be closed to protect the fuse against transient current conditions and controllable to be open after the transient current conditions have subsided to allow the fuse to operate normally.

### TECHNICAL FIELD

The subject matter described herein relates to methods and systems for providing and distributing direct current (DC) power. More particularly, the subject matter described herein relates to methods, systems, and computer readable media for protection of DC building electrical systems.

### BACKGROUND

Alternative energy sources such as wind and solar power produce DC power, which must then be integrated into existing alternating current (AC) power grids, e.g., by using inverters that convert DC to AC. Historically, homes and offices distribute AC power to power outlets throughout the building. Many devices within homes and offices, most notably computers and other electronic equipment, use DC power, and thus include power adapters that convert the AC power that is provided to the power outlet into the DC power required by the device. Other devices, such as lamps, are designed for AC power but could also be powered by DC power instead. Thus, there is rising interest in distributing DC power, rather than AC power, throughout homes, offices, or other buildings. Having DC power distribution has an advantage that alternative energy sources and backup power sources that produce DC power, such as photovoltaic (PV) cells, wind generators, and storage batteries, for example, can be connected to the power grid without requiring DC-to-AC inverters.

There are disadvantages associated with DC power distribution, however. Because DC power sources tend to use capacitors or other charge-storing devices to filter voltage ripples caused by rectifier circuits, for example, fault conditions in the distribution network can cause large current spikes as these capacitors are drained, which can in turn cause circuit damage to devices connected to the DC power source, or to the DC power source itself. Thus, there is a need to provide circuit protection throughout the DC power distribution infrastructure.

Conventional approaches to circuit protection include using fuses or circuit breakers. Fuses and circuit breakers are both designed to blow (trip) when the current through them exceeds the preset thresholds, but they have to be specially arranged and coordinated to have the appropriate selectivity—i.e. downstream devices breaking faster than the upstream devices to isolate just the faulty circuit. Depending on its current breaking capability, a relatively low cost DC circuit breaker works well when the current under a high impedance fault (HIF) condition is slightly higher than the rated current for the circuit breaker, but the same circuit breaker may not work well under a low impedance fault, or the bolted fault (BF) condition, in which case there may be arcing across the open contacts, or the overload condition may have caused the circuit breaker to melt in the closed position, to give two examples. On the other hand, transient conditions in DC power grids may result in current spikes (inrush current) that are larger than would occur in similarly rated AC power grids, due to the use of storage capacitors. It is possible to design circuit breakers that can handle these large inrush currents yet have fast breaking time, but such circuit breakers are much more expensive than circuit breakers that don't need to handle such inrush currents.

Fuses can protect against higher fault current conditions than circuit breakers can withstand at a lower cost, but conventional fuses must be replaced after one protection operation, which is troublesome in practical applications. Fast acting fuses can provide greater protection against HIF conditions, but fast acting fuses have the disadvantage that they may not be able to withstand the inrush current that occurs while capacitors charge without blowing itself.

Thus, there is a need for protection mechanisms that can inexpensively handle both the BF and HIF conditions, that may occur on DC power distribution systems, and especially DC building electrical systems.

In addition, faults such as a short to ground within a DC power distribution system, can cause under-voltage conditions that damage the circuits of DC power sources as they increase their power output in a futile attempt to raise the DC voltage to a proper level. Thus, there is a need for protection mechanisms that not only protect components on DC building electrical systems from damage caused by high current spikes but that also handle under-voltage conditions.

Accordingly, in light of these disadvantages associated with conventional DC power distribution, there exists a need for methods, systems, and computer readable media for protection of DC building electrical systems.

### SUMMARY

According to one aspect, the subject matter described herein includes a direct current (DC) protection module for protection of DC building electrical systems, the module including a fuse for protection against high current faults, a normally closed switch connected in parallel with the fuse, and a circuit breaker connected in series with the fuse and switch for protection against both the BF and HIF conditions. The switch is controllable to be closed to protect the fuse against transient current conditions and to be open to allow the fuse to operate normally.

According to another aspect, the subject matter described herein includes a system for over-current protection of direct current (DC) building electrical systems. The system includes a DC bus for providing DC power to a building and multiple DC feeder conductors for providing DC power to multiple locations within the building. Each DC feeder conductor is connected to the DC bus via a DC protection module that includes a fuse, a normally closed switch connected in parallel with the fuse, and a circuit breaker connected in series with the fuse and switch, where the switch is controllable to be closed to protect the fuse against transient current conditions and controllable to be open after the transient current conditions have subsided to allow the fuse to operate normally.

According to yet another aspect, the subject matter described herein includes a system for undervoltage protection of direct current (DC) building electrical systems. The system includes a DC bus for providing DC power to a building, a DC supply for providing DC power to the DC bus, the DC supply including a DC/DC converter, and a control circuit. The control circuit detects an undervoltage condition on the DC bus, and, in response to detecting the undervoltage condition, controls the DC/DC converter to limit a current that the DC supply provides to the DC bus.

According to yet another aspect, the subject matter described herein includes a method for over-current protection of direct current (DC) building electrical systems. The method includes, in a DC building electrical system having a DC bus for providing DC power to a plurality of DC feeder conductors for providing DC power to a plurality of locations within a building, wherein each DC feeder conductor is connected to the DC bus via a DC protection module comprising a fuse, a normally closed switch connected in parallel with the fuse, and a circuit breaker connected in series with the fuse and switch, controlling the switch to be closed to protect the fuse against transient current conditions and, after the transient current conditions have subsided, controlling the switch to be open to allow the fuse to operate normally.

According to yet another aspect, the subject matter described herein includes a method for undervoltage protection of direct current (DC) building electrical systems. The method includes, in a DC building electrical system having a DC power supply connected to a DC bus for providing DC power to a building, the DC power supply including a DC/DC converter, detecting an undervoltage condition on the DC bus, and, in response to detecting the undervoltage condition on the DC bus, controlling the DC/DC converter to limit a current that the DC power supply provides to the DC bus.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a block diagram illustrating an exemplary system for over-current protection of DC building electrical systems according to an embodiment of the subject matter described herein;

FIG. 2 is a graph illustrating transient current conditions present on a DC grid during power-on;

FIG. 3 is a schematic diagram illustrating an exemplary DC protection module for providing protection of DC building electrical systems according to an embodiment of the subject matter described herein;

FIG. 4 is a flow chart illustrating an exemplary process for over-current protection of DC building electrical systems according to an embodiment of the subject matter described herein;

FIG. 5 is a block diagram illustrating an exemplary system for undervoltage protection of DC building electrical systems according to an embodiment of the subject matter described herein; and

FIG. 6 is a flow chart illustrating an exemplary process for undervoltage protection of DC building electrical systems according to an embodiment of the subject matter described herein.

### DETAILED DESCRIPTION

In accordance with the subject matter disclosed herein, systems, methods, and computer readable media are provided for protection of DC building electrical systems. Reference will now be made in detail to exemplary embodiments of the present invention, examples of which are illustrated in the accompanying drawings. Wherever possible, the same reference numbers will be used throughout the drawings to refer to the same or like parts.

The subject matter described herein relates to the protection of DC power supply systems of building electrical networks and similar circuits. It presents the low voltage direct current (LVDC) building protection concept. As used herein, the term “low voltage DC” refers to DC voltage of 1 kV or less. A fuse, an switch and a circuit breaker integration method is provided that meets the special requirements of LVDC feeder protection. An under-voltage protection scheme is presented to limit the contribution of fault current to LVDC faults through the adjustment of DC/DC converter settings, so that a less capable and cost protection device can be used in LVDC buildings with local energy sources such as photovoltaic and battery energy storage.

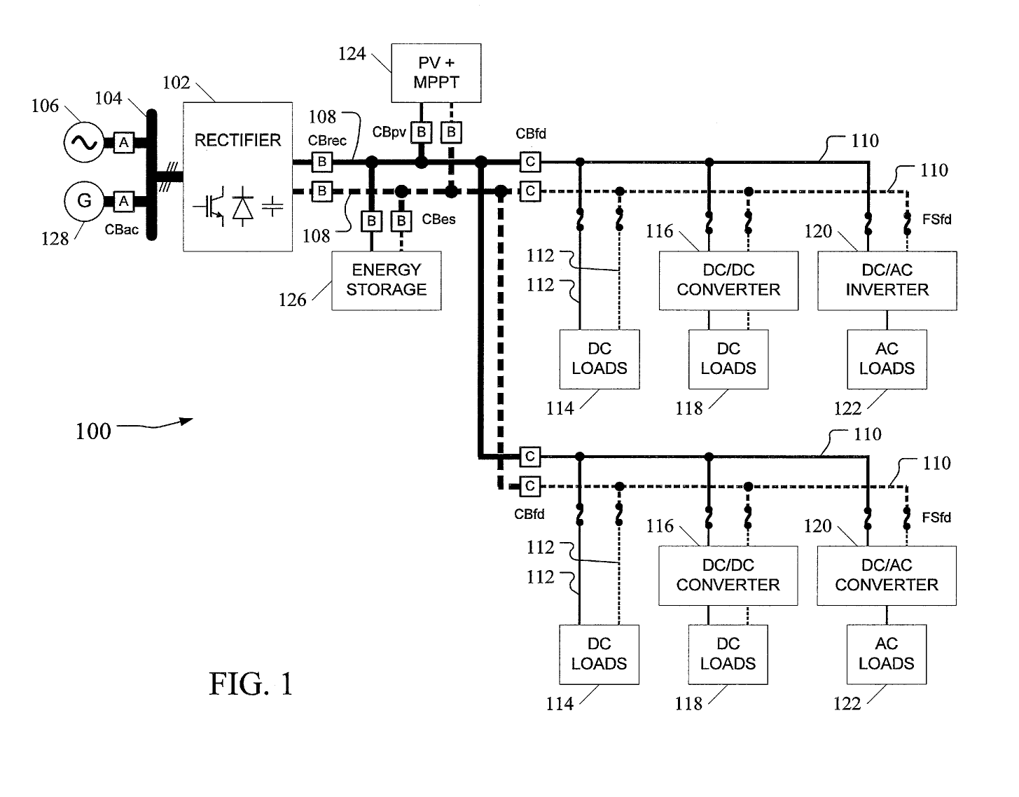

FIG. 1 is a block diagram illustrating an exemplary system for protection of DC building electrical systems according to an embodiment of the subject matter described herein. In the embodiment illustrated in FIG. 1, LVDC system 100 includes a centralized rectifier 102 connected to an AC power grid 104 that is supplied power by an AC supply (or generator) 106 and that provides DC to all of the loads via a hierarchy of conductors referred to as the DC bus 108, which provide power to one or more DC distribution conductors 110, which in turn provide power to one or more lateral conductors 112 (also known as “feeder conductors” or simply “feeders”), which provide power to the loads.

Loads may be connected to lateral conductors 112 directly, such as DC loads 114, or indirectly through converters 116, such as DC loads 118, or through inverters 120, such as AC loads 122. In one embodiment, DC distribution conductors 110 are inside building floors and may operate as a floor bus and/or feeders. This type of system has many applications, including as what will be referred to herein as a “high-end building LVDC system”.

System 100 may include renewable power generation, energy storage devices, and/or emergency power generators to improve the reliability of the system. In the embodiment illustrated in FIG. 1, for example, system 100 includes photovoltaic panels (PV) 124. Other examples of renewable power sources include, but are not limited to, wind generators, geothermal generators, tidal power generators, and other forms of renewable power. In the embodiment illustrated in FIG. 1, system 100 also includes an energy storage device 126, such as a battery, and an emergency AC generator 128.

In LVDC systems such as system 100, a comprehensive protection system should not only protect the loads but also protect other components of the system, including the power supplies and energy storage devices. A protection system may include a number of protection devices, including circuit breakers, switches, and fuses. The protection targets in an LVDC system such as system 100 include rectifier 102, DC bus 108, and DC distribution conductors 110.

In the embodiment illustrated in FIG. 1, for example, system 100 includes AC bus protection circuit breakers CBac, which as the last defense line protects against any downstream fault conditions in the system. DC bus protection circuit breakers CBrec protect rectifier 102 from overcurrent conditions and also protect rectifier 102 from undervoltage conditions on DC bus 108. DC bus protection circuit breakers CBpv protect PV 124 and DC bus 108 from each other, and DC bus protection circuit breakers CBes protect energy storage 126 and DC bus 108 from each other. DC distribution circuit breakers CBfd protect DC distribution conductors 110 and feeder conductors 112 from DC bus 108, and vice versa. DC feeder protection devices FSfd provide further protection between DC distribution conductors 110 and feeder conductors 112. Protection of AC grid 106 and emergency AC generator 128 have known practices and are out of the scope of this invention.

For rectifier protection of faults downstream of rectifier 102, over-current detection and automatic power device blocking inside rectifier 102, backup AC protection circuit breaker CBac and the circuit breakers immediately after the rectifier CBrec work together to achieve the goal. If the power device of rectifier 102 is able to block the over-current, the over-current detection and automatic power device blocking function of rectifier 102 is the first line of defense and can respond very quickly (in a few milliseconds). However, if the fault current is not interrupted by CBrec or CBac in time, the power devices (diodes, thyristors) of rectifier 102 can be destroyed. This requires coordination of protection settings between CBac and CBrec.

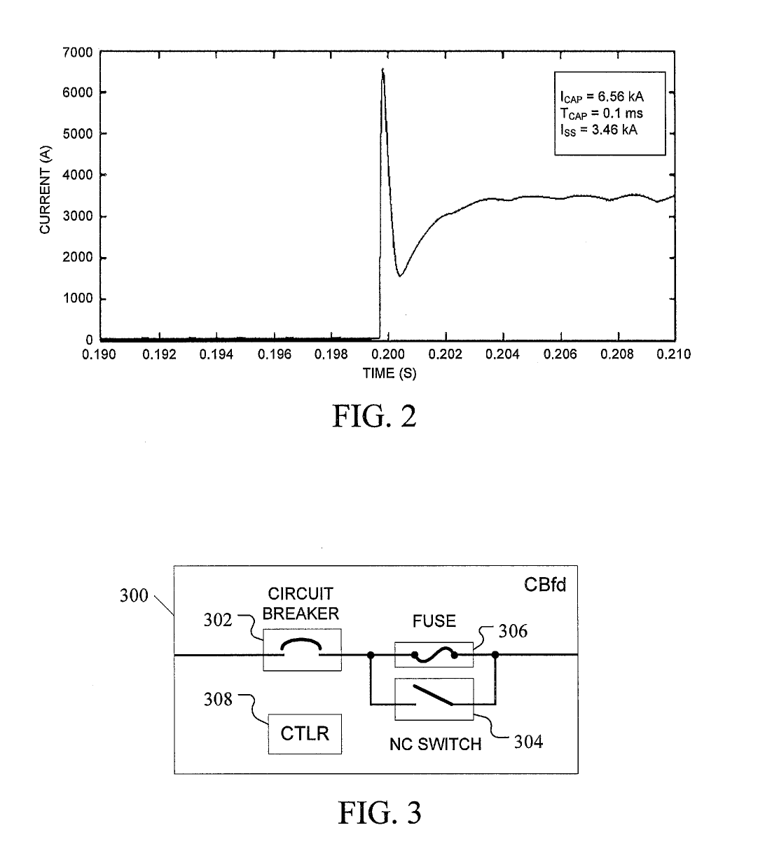

FIG. 2 is a graph illustrating transient current conditions present on a DC grid during power-on. Since rectifier 102 normally has a large filtering capacitor attached to its output, when a fault is downstream of CBrec, the fault current going through CBrec can have a large initial peak as shown in FIG. 2. The fast rising part of the first peak can be used to detect the fault and if necessary, trip CBrec quickly.

If the fault is within the boundary set by CBrec, CBpv, CBes and CBfd, the bus protection circuit breakers CBrec, CBpv and CBes will work together to achieve the goal. The DC fault current going through CBrec, CBpv and CBes will still look like FIG. 2, where the initial capacitor discharge can cause a very high initial peak. A self-protection function of the converter within PV 124 can be implemented to reduce its contribution to the fault current and isolate it from the DC circuit.

When faults are on DC distribution feeder 110, CBfd can clear and isolate the fault before CBrec, CBpv, and CBes. When faults are on DC laterals 112, CBfd serves as the backup protection device for FSfd. In one embodiment, the following requirements may apply to CBfd selection in a real system:
Since the initial DC fault current of capacitor discharging is very fast (typically less than 3 ms), the DC circuit breaker or fuse based CBfd's fault current limiting feature may not be very effective. The steady state fault current level Iss has to be used to determine the interrupting capability of CBfd.
Conservative DC circuit protection design requires the application of higher interrupting circuit breakers such as molded-case circuit breakers (MCCB) to serve as CBfd. However, these circuit breakers' minimum continuous current loading level is generally higher than miniature circuit breaker (MCB), and their costs may be prohibitive for LVDC building feeder protection.
Since CBfd is the first device for feeder protection and backup device for DC lateral protection, it must act faster (in less than 10 ms) than CBrec, CBpv, and CBes to clear and isolate a feeder fault, and slower than FSfd to allow FSfd to clear and isolate a lateral fault. The protection selectivity coordination based on existing protection devices is challenging because pick-up settings cannot be too far apart for CBfd and FSfd, due to the short conductor length between CBfd and FSfd and therefore the not-so-much-different fault path impedance and fault current levels.
The power electronics devices (rectifier 102, for example) in the DC circuit are quite sensitive to overloading conditions, and they must be protected against such conditions. This calls for a low pick-up protection setting with relatively longer tripping time.
The inrush current passing through CBfd is close to the fault current in amplitude. This inrush must not cause the CBfd to trip.

FIG. 3 is a schematic diagram illustrating an exemplary DC protection module for providing protection of DC building electrical systems according to an embodiment of the subject matter described herein. FIG. 3 illustrates a protection device having a configuration that meets the requirements listed above. In the embodiment illustrated in FIG. 3, protection device 300 includes the combination of a lower rating DC circuit breaker 302 together with a normally closed (NC) switch 304, and a fuse 306. In one embodiment, fuse 306 is in parallel with NC switch 304, and together they are in series with circuit breaker 302. In one embodiment, DC circuit breaker 302 may be a miniature circuit breaker (MCB). Referring to the system illustrated in FIG. 1, for example, protection device 300 may be used as a FSfd, a CBfd, a CBpv, a CBes, a CBrec, or in another locations within the LVDC network.

In one embodiment, fuse 306 may be a fast-acting fuse. In the context of this invention, a fast acting fuse is an instantaneously blown fuse, i.e. as soon as the current it carries exceeds its pick up current (assumed to be a few times higher than the circuit breaker pick-up current), it will blow. Normal fuses, in contrast, are designed to tolerate a short current spike above the rated current, rather than blow immediately if the current exceeds the rated current. The addition of NC switch 304 in parallel with fuse 306 to bypass and protect fuse 306 from transient current conditions, such as inrush current, allows fuse 306 to be a fast-acting type, if desired, but the same principle can be applied to protect normal (e.g., non-fast-acting type) fuses from inrush current or other transient currents as well, in places where a fast-acting fuse is not essential, for example.

An example operation of protection device 300 is as follows:

When protection device 300 is closed for the first time, switch 304 should be in closed position before circuit breaker 302 closes. Since switch 304 is of NC type, this condition should be met automatically. The reason for this sequence is that when power is initially provided to a distribution feeder, such as DC distribution conductors 110 and feeder conductors 112 in FIG. 1, the power-on event may involve the charging of input filter capacitors at the power electronics based loads, in which case the charging current amplitude may come close to fault current levels. Having switch 304 in parallel with fuse 306 will protect the fuse from blowing. Since the inrush current's duration is short, it will not cause circuit breaker 302 to trip.

After the device is fully switched on to its load, switch 304 is opened. Now the full load current will flow through circuit breaker 302 and fuse 306. Switch 304 should remain in open position if both fuse 306 and circuit breaker 302 are closed. In one embodiment, switch 304 may be closed and opened manually. In another embodiment, switch 304 may be closed and opened automatically, under the control of a sensing circuit that may be contained within protection device 300. For example, in one embodiment, protection device 300 may include a circuit that closes switch 304 during an initialization condition, such as power-on reset or closing of circuit breaker 302, then waits a programmed amount of time after the initialization condition before opening switch 304. In another embodiment, protection device 300 may include a circuit for closing switch 304 during an initialization condition and for detecting transient conditions and opening switch 304 only after the transient conditions have subsided and are no longer being detected. In yet another embodiment, switch 304 may be opened and closed automatically but have the ability to be manually overridden if necessary.

Circuit breaker 302 can be set to trip upon an overloading condition, especially when the overloading is mild. This is important for the protection of power electronics based equipment in the system, such as the rectifier in FIG. 1. Circuit breaker 302 can trip this relatively small abnormal current (assume it is above the pick-up current of the circuit breaker and lower significantly than the pick-up current of the fuse) and reclose when the overloading condition is removed.

If there is a bolted fault in the system, for example, system line-to-line short circuit fault or ground fault, the large steady state fault current is beyond the current breaking capability of circuit breaker 302 by design. However, since switch 304 is open, fuse 306 will blow to isolate the fault. The pickup current of fuse 306 can be set high enough (still lower than the steady state fault current of a fault on the feeder) to have good selective protection coordination with the downstream FSfd.

Once the bolted fault is cleared by the fuse, circuit breaker 302 can open and switch 304 can be closed afterward. After clearing the fault condition and before the blown fuse or its link is replaced, both switch 304 and circuit breaker 302 can be temporarily closed to restore the power.

This operation can save the number of spare fuses the user has to maintain in stock, and also reduce the outage time of the downstream circuit. This will also allow a live replacement of the blown fuse or its link.

In one embodiment, this concept can be extended by enabling remote communication and control of protection device 300 from a central controller of the building management system. In one embodiment, the central controller may send commands to switch 304 and circuit breaker 302 separately, and may get feedback and/or status information from them as well. In one embodiment, protection device 300 may include a controller circuit or control logic 308 that controls portions of protection device 300 and communicates with a central controller of the building management system.

The subject matter described herein has several advantages over conventional fused circuit breakers, known as “FCBs”. For example, FCBs have a fuse in series with each pole, are more costly, and may blow their fuse in the presence of the DC inrush (charging) current. In contrast, switch 304 of protection device 300 protects fuse 306 from DC inrush or charging current, which means that the fuse 306 blows only when it really needs to. Also, when an FCB blows its fuse component in a fault, the service cannot be restored until the fuse is replaced. In contrast, switch 304 of protection device 300 may be closed as a temporary or emergency measure to restore service between the time that the fuse is blown until the time that the fuse can be replaced by service personnel.

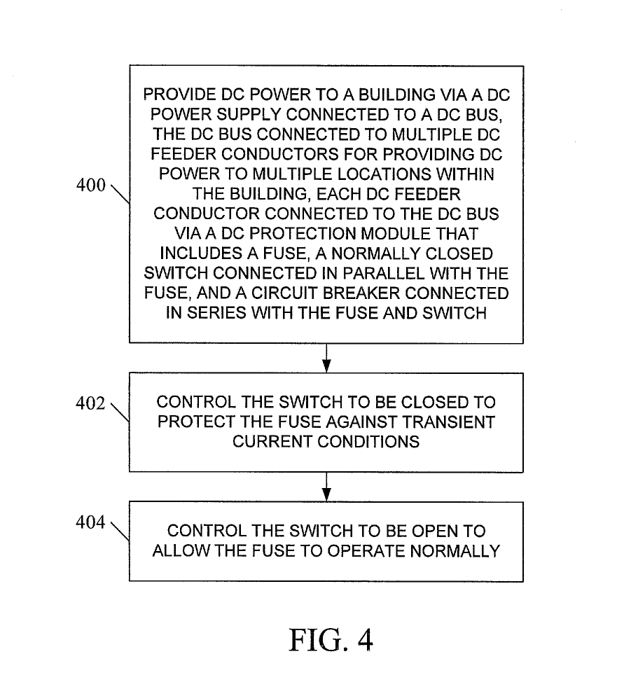

FIG. 4 is a flow chart illustrating an exemplary process for over-current protection of DC building electrical systems according to an embodiment of the subject matter described herein. In the embodiment illustrated in FIG. 4, the process includes, at step 400, providing DC power to a building via a DC power supply connected to a DC bus, the DC bus connected to multiple DC feeder conductors for providing DC power to multiple locations within the building, each Dc feeder conductor connected to the DC bus via a DC protection module that includes a fuse (which may be a fast-acting fuse) a normally closed switch connected in parallel with the fuse, and a circuit breaker connected in series with the fuse and switch. In one embodiment, a system such as system 100 in FIG. 1 will be the result after performing step 400. System 100 includes a DC bus 106, DC distribution network 108, and multiple DC feeders 110, each feeder connected to DC bus 106 through protection devices such as CBfd and/or FSfd one or both of which may be a DC protection module 300.

At step 402, the switch within each DC protection module is controlled to be closed to protect the fuse against transient current conditions, such as those that occur during initial power-on of the DC bus.

At step 404, the switch within each DC protection module is controlled to be open to allow the fuse to operate normally, such as after the transient current conditions associated with initial power-on have subsided or abated.

The subject matter disclosed herein also includes an undervoltage protection scheme for the local energy resources, and is ideally suited for protection of a photovoltaic cell or other energy source that uses maximum power point tracking (MPPT). Simulations have shown that these local energy sources can contribute to fault current during a fault on the DC bus or DC feeders/laterals.

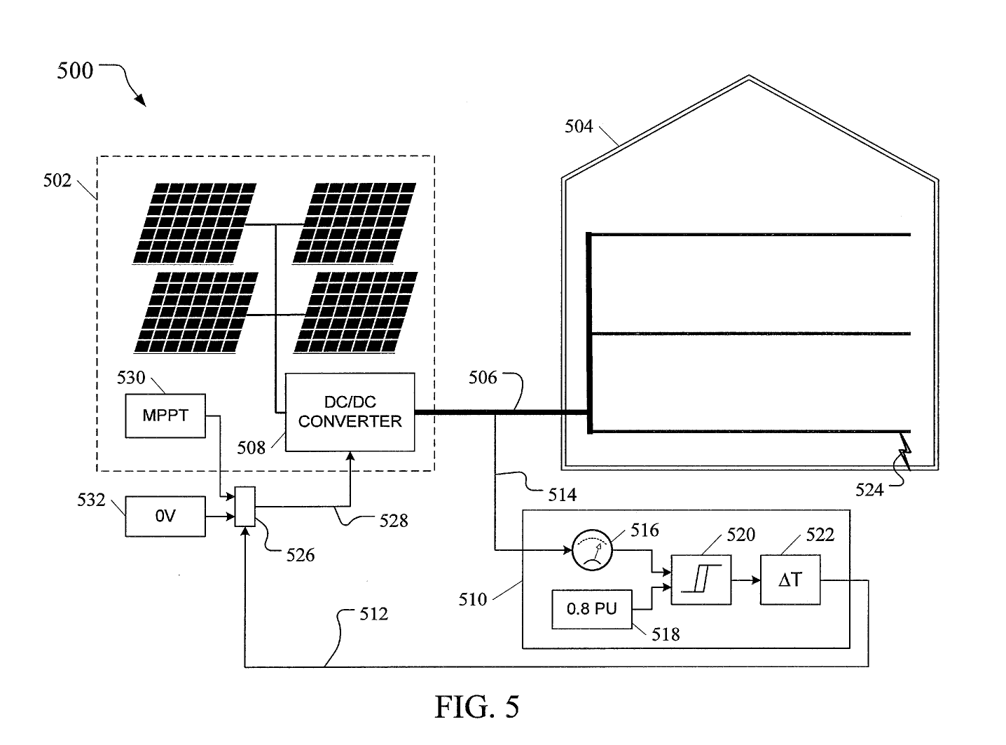

FIG. 5 is a block diagram illustrating an exemplary system for undervoltage protection of DC building electrical systems according to an embodiment of the subject matter described herein. In the embodiment illustrated in FIG. 5, system 500 includes a DC supply 502 that supplies DC power to a building 504 via a DC bus 506. DC supply 502 includes a DC/DC converter 508. In the embodiment illustrated in FIG. 5, DC supply 502 is an array of solar panels or photovoltaic cells that provide power to DC/DC converter 508, which generates a suitable voltage for DC bus 506. In alternative embodiments, DC supply 502 can provide power from wind, tidal, geothermal, or other sources of energy.

A control circuit 510 detects an undervoltage condition on DC bus 506 and responds by controlling DC/DC converter 508 to limit the current that DC supply 502 provides to DC bus 506. In the embodiment illustrated in FIG. 5, for example, control circuit 510 outputs a control signal 512 for controlling DC/DC converter 508. In one embodiment, control circuit 510 may monitor the voltage of DC bus 506 via a tap or sensor 514, which provides current voltage conditions of DC bus 506 to a measuring unit 516. In one embodiment, the current voltage of DC bus 506 as reported by measuring unit 516 is compared to a programmable threshold value 518 by a comparison circuit 520 to determine whether an undervoltage condition exists.

In one embodiment, comparison circuit 520 may include a hysteresis function to prevent rapid toggling of the control signal 512 of control circuit 510 when the measured voltage on DC bus 506 is around the threshold value 518. In one embodiment, for example, a first threshold value may be used to trigger the actions taken by control circuit 510 to limit the current provided by DC/DC converter 508, and another threshold value may be used to detect the abatement of the undervoltage condition. By setting the value of the first threshold to be different from the value of the second threshold, hysteresis may be achieved.

In one embodiment, control circuit 510 may include a delay function 522 for imposing a certain amount of delay before changing the operation of DC/DC converter 508. The delay imposed by delay function 522 and the hysteresis imposed by comparison circuit 520 together operate to stabilize the output of control circuit 510 by avoiding rapid fluctuations of control output 512.

Control output 512 directly or indirectly controls DC/DC converter 508 to reduce the current that DC/DC converter 508 provides to DC bus 506 during an undervoltage condition. For example, in the event of a fault to ground 524 as shown in FIG. 5, the voltage on DC bus 506 will drop to zero or some value between zero and the normal voltage present on DC bus 506. Without the control signal 512 provided by control circuit 510, DC/DC converter 508 would attempt to compensate for the drop in voltage on DC bus 506 by providing more current to DC bus 506, under the assumption—reasonable during normal, non-fault operation—that the voltage drop on DC bus 506 was caused by an increase in load. During a fault condition such as the one illustrated in FIG. 5, however, that response by DC/DC converter 508 would result in dangerously high current levels on DC bus 506, which could damage both DC bus 506 and DC/DC converter 508. With control circuit 510, however, control signal 512 can prevent DC/DC converter 508 from producing excessively high current.

In one embodiment control signal 512 may be used as a select line into a selector 526 which selects one of its two inputs to be provided to DC/DC converter as a voltage reference 528. In the embodiment illustrated in FIG. 5, for example, DC supply 502 includes a controller 530 that implements a maximum power point tracking (MPPT) algorithm. The output of controller 530 is a reference voltage that, under normal conditions, is provided as voltage reference 528 to DC/DC converter 508. During an undervoltage condition, however, control signal 512 controls selector 526 to provide a reference voltage 532 as voltage reference 528 to DC/DC controller 508 in place of the reference voltage provided by the MPPT algorithm. In the embodiment illustrated in FIG. 5, reference voltage 532 is shown as “0 volts”, but other values are contemplated. In an alternative embodiment, control circuit 510 may provide the reference voltage 532 directly. These embodiments allow control circuit 510 to dynamically adjust the reference voltage 532 that is delivered to DC/DC converter 508.

By providing a zero volt reference into DC/DC converter 506, DC/DC converter 506 will drive its output voltage to zero volts, which will cause the current produced by DC supply 502 to be reduced or eliminated. In this manner, DC supply 502 reduces or eliminates its contribution to fault current present on DC bus 506. If DC supply 502 is the only source of DC power in system 500, the action taken by control circuit 510 will cause the fault current to cease.

In one embodiment, when control circuit 510 detects that the undervoltage condition has subsided, control signal 512 may re-engage controller 530 to provide a voltage reference 528 according to the MPPT algorithm. As mentioned above, control circuit 510 may impose a delay and/or hysteresis during the recovery process.

The examples of how control circuit 510 may control DC/DC converter 508 to reduce its contribution to current on DC bus 506 during an undervoltage condition are intended to be illustrative and not limiting. Other control schemes are contemplated.

The undervoltage protection scheme illustrated in FIG. 5 may also be applied to an energy storage device, such as energy storage module 124 of FIG. 1. In one embodiment, control circuit 510 may use control signal 512 as a means to set the output power level of the DC/DC converter rather than the battery-side voltage, which may not be controllable. In one embodiment, the reference output power setting of the DC/DC converter may be set not to zero but set instead to a very low level to limit the fault current contribution from the energy storage, depending on the topology. Some topologies may require anti-windup in the feedback control during this operating mode if the antiparallel diodes in the converter bypass the controlled switches. This ensures that the converter is able to properly resume normal operation after the fault has been cleared.

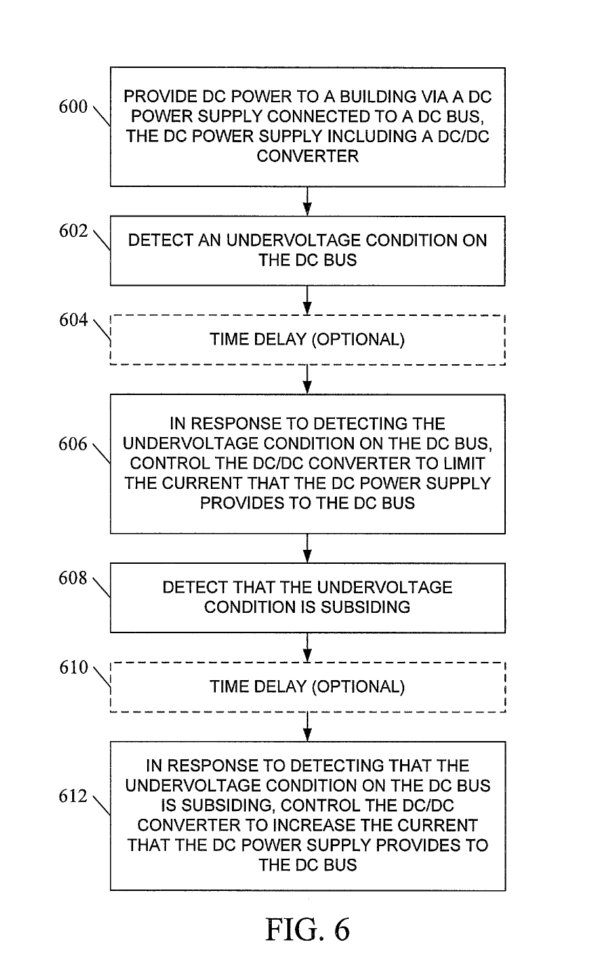

FIG. 6 is a flow chart illustrating an exemplary process for undervoltage protection of DC building electrical systems according to an embodiment of the subject matter described herein. In the embodiment illustrated in FIG. 6, the method includes, at step 600, providing DC power to a building via a DC power supply connected to a DC bus, the DC power supply including a DC/DC converter. Referring to FIG. 5, for example, DC supply 502, which includes DC/DC converter 508, provides DC power to building 504 via DC bus 506.

At step 602, an undervoltage condition is detected on the DC bus. In the embodiment illustrated in FIG. 5, for example, control circuit 510 may detect an undervoltage condition on DC bus 506 via sensor or tap 512. In one embodiment, detection of an undervoltage condition may include, but is not limited to, determining that the DC voltage present on the DC bus is below a first threshold value, determining that the DC voltage present on the DC bus is below a second threshold value for a first threshold amount of time, determining that the DC voltage present on the DC bus is dropping at or above a first threshold rate, and determining that the DC voltage present on the DC bus is dropping at or above a second threshold rate for a second threshold amount of time.

At step 604, an optional time delay may be imposed before going to step 606. In the embodiment illustrated in FIG. 5, for example, delay function 522 may delay the change in control signal 512.

At step 606, in response to detecting the undervoltage condition on the DC bus, the DC/DC converter is controlled to limit the current that the DC power supply provides to the DC bus. In the embodiment illustrated in FIG. 5, for example, control signal 512 signals selector 526 to provide zero volts to DC/DC converter via reference voltage 528, bypassing the control voltage otherwise provided to DC/DC converter 508 from the MPPT controller 530.

In one embodiment, the method also includes a recovery procedure, which includes, at step 608, detecting that the undervoltage condition is subsiding or has subsided. In the embodiment illustrated in FIG. 5, for example, control circuit 510 may detect that the DC voltage present on the DC bus is above a second threshold value. In one embodiment, the threshold value used to determine that the undervoltage condition is subsiding may be above the threshold value used to determine that the undervoltage condition is occurring. In this manner, the control system exhibits hysteresis.

At step 610, an optional time delay may be imposed, such as by delay function 522 in control circuit 510 as shown in FIG. 5.

At step 612, in response to detecting that the DC voltage present on the DC bus is above a second threshold value, the DC/DC converter is controlled to increase the current that the DC supply provides to the DC bus. In the embodiment illustrated in FIG. 5, for example, control circuit 510 may signal selector 526 to select the output of MPPT controller 530 as the input to be provided to DC/DC converter 508 as reference voltage 528.

The current limiting criteria and mechanisms described above for alternative energy sources and energy storage devices that use DC/DC converters are easy to implement and effective. They can also reduce the requirements for LVDC protection devices to lower the total system cost. The subject matter described herein relates to the protection of LVDC power supply systems for industrial and commercial buildings, but can be applied to other utility supplied LVDC systems as well.

It will be understood that various details of the subject matter described herein may be changed without departing from the scope of the subject matter described herein. Furthermore, the foregoing description is for the purpose of illustration only, and not for the purpose of limitation.

What is claimed is:

1. A direct current (DC) protection module for protection of DC building electrical systems, the module comprising:
a fuse for protection against high current faults;
a normally closed switch connected in parallel with the fuse; and
a circuit breaker connected in series with the fuse and switch for protection against low current overloading conditions,
wherein the switch is controllable to be closed to protect the fuse against transient current conditions and controllable to be open to allow the fuse to operate normally.

2. The DC protection module of claim 1 wherein the fuse is a fast-acting type.

3. A system for over-current protection of direct current (DC) building electrical systems, the system comprising:
a DC bus for providing DC power to a building; and
a plurality of DC feeder conductors for providing DC power to a plurality of locations within the building, wherein each DC feeder conductor is connected to the DC bus via a DC protection module comprising a fuse, a normally closed switch connected in parallel with the fuse, and a circuit breaker connected in series with the fuse and switch, wherein the switch is controllable to be closed to protect the fuse against transient current conditions and controllable to be open after the transient current conditions have subsided to allow the fuse to operate normally.

4. The system of claim 3 wherein the normally closed switch in each DC protection module is controlled to be closed during initial power-on of the DC bus.

5. The system of claim 3 wherein the normally closed switch in each DC protection module is controlled to be open after the transient current conditions that occur during initial power-on have subsided.

6. A system for undervoltage protection of direct current (DC) building electrical systems, the system comprising:
a DC bus for providing DC power to a building;
a DC supply for providing DC power to the DC bus, the DC supply including a DC/DC converter; and
a control circuit configured for detecting an undervoltage condition on the DC bus, and, in response to detecting the undervoltage condition, controlling the DC/DC converter to limit a current that the DC supply provides to the DC bus.

7. The system of claim 6 wherein detecting the undervoltage condition comprises at least one of:
determining that the DC voltage present on the DC bus is below a first threshold value;
determining that the DC voltage present on the DC bus is below a second threshold value for a first threshold amount of time;
determining that the DC voltage present on the DC bus is dropping at or above a first threshold rate; and
determining that the DC voltage present on the DC bus is dropping at or above a second threshold rate for a second threshold amount of time.

8. The system of claim 6 wherein the control circuit is configured to wait a specified delay time after detection of the undervoltage condition before controlling the DC/DC converter to limit the current that the DC supply provides to the DC bus.

9. The system of claim 6 wherein the control circuit is configured for detecting that the DC voltage present on the DC bus is above a second threshold value, and in response to detecting that the DC voltage present on the DC bus is above a second threshold value, controlling the DC/DC converter to increase the current that the DC supply provides to the DC bus.

10. The system of claim 9 wherein the second threshold value is above the first threshold value.

11. The system of claim 6 wherein the DC supply comprises at least one of:
a rectifier for converting alternating current (AC) to DC;
an energy storage device for providing DC power;
a photovoltaic panel or solar cell;
a wind-powered generator;
a geothermal power generator; and
a tidal power generator.

12. A method for over-current protection of direct current (DC) building electrical systems, the method comprising:
in a DC building electrical system having a DC bus for providing DC power to a plurality of DC feeder conductors for providing DC power to a plurality of locations within a building, wherein each DC feeder conductor is connected to the DC bus via a DC protection module comprising a fuse, a normally closed switch connected in parallel with the fuse, and a circuit breaker connected in series with the fuse and switch:
controlling the switch to be closed to protect the fuse against transient current conditions; and
after the transient current conditions have subsided, controlling the switch to be open to allow the fuse to operate normally.

13. The method of claim 12 wherein controlling the switch to be closed to protect the fuse against transient current conditions includes controlling the switch to be closed during initial power-on of the DC bus.

14. The method of claim 12 wherein controlling the switch to be open to allow the fuse to operate normally includes controlling the switch to be open after the transient current conditions that occur during initial power-on have subsided.

15. The method of claim 12 embodied as a plurality of machine-readable instructions stored on a non-transitory computer readable storage medium and configured to be executed by at least one computer processor to perform the method.

16. A method for undervoltage protection of direct current (DC) building electrical systems, the method comprising:
in a DC building electrical system having a DC power supply connected to a DC bus for providing DC power to a building, the DC power supply including a DC/DC converter:
detecting an undervoltage condition on the DC bus; and
in response to detecting the undervoltage condition on the DC bus, controlling the DC/DC converter to limit a current that the DC power supply provides to the DC bus.

17. The method of claim 16 wherein detecting the undervoltage condition comprises at least one of:
determining that the DC voltage present on the DC bus is below a first threshold value;
determining that the DC voltage present on the DC bus is below a second threshold value for a first threshold amount of time;
determining that the DC voltage present on the DC bus is dropping at or above a first threshold rate; and
determining that the DC voltage present on the DC bus is dropping at or above a second threshold rate for a second threshold amount of time.

18. The method of claim 16 comprising waiting a specified delay time between detection of the undervoltage condition and controlling the DC/DC converter to limit the current that the DC supply provides to the DC bus.

19. The method of claim 16 comprising:
detecting that the DC voltage present on the DC bus is above a second threshold value; and
in response to detecting that the DC voltage present on the DC bus is above a second threshold value, controlling the DC/DC converter to increase the current that the DC supply provides to the DC bus.

20. The method of claim 19 wherein the second threshold value is above the first threshold value.

21. The method of claim 16 wherein providing DC power to a building via a DC power supply comprises providing DC power using at least one of:
a rectifier for converting alternating current (AC) to DC;
an energy storage device for providing DC power;
a photovoltaic panel or solar cell;
a wind-powered generator;
a geothermal power generator; and
a tidal power generator.

22. The method of claim 16 embodied as a plurality of machine-readable instructions stored on a non-transitory computer readable storage medium and configured to be executed by at least one computer processor to perform the method.
